(19) United States
(12) Patent Application Publication
(10) Pub. No.: US 2008/0296880 A1
(43) Pub. Date: Dec. 4, 2008

(54) Method and device for protecting a motorcycle

(76) Inventor: Hsiu-Ping Lin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/902,517

(22) Filed: Sep. 21, 2007

Related U.S. Application Data
(63) Continuation-in-part of application No. 11/806,844, filed on Jun. 4, 2007.

(51) Int. Cl. B60R 27/00

(52) U.S. Cl. 280/770

(57) ABSTRACT

A protecting device for a motorcycle. The protecting device may comprise a tilt-measuring module capable of measuring tilt of the motorcycle, an airbag capable of being inflated and expanding out of or to cover an outer surface of the motorcycle, a comparing module capable of comparing the tilt with a tilting limitation and generating a inflating signal if the tilt achieves or exceeds the tilting limitation and an inflation module capable of generating a gas to inflate the airbag if the inflation module receives the inflating signal.

### CROSS-REFERENCE TO RELATED DOCUMENTS

The present invention is a continuation in part (CIP) to a U.S. patent application Ser. No. 11/806,844 entitled “Method and device for protecting a motorcycle” filed on Jun. 4, 2007.

### BACKGROUND OF THE INVENTION

The present invention relates generally to a method or a device for protecting a motorcycle, and more particularly, to a protecting method or device using an airbag capable of expanding out of or to cover a surface of a motorcycle to protecting the motorcycle.

Airbags that work with inflators and sensors applied as protecting devices may generally be used inside cars and may be capable of providing another level of protection to passengers of the cars in the event of car accidents. To motorcycles, some examples of prior art for providing airbags in motorcycles are illustrated in related U.S. patents such as U.S. Pat. No. 6,848,709 to Nagatsuyu, U.S. Pat. No. 7,029,029 to Yamazaki et. al. and U.S. Pat. No. 7,198,287 to Miyata, etc. The related U.S. patents disclose airbags which may be designed to prevent injury by keeping riders' heads, chests or genitals from directly impacting steering wheels, dashboards, fuel tanks or windshields of the motorcycles if the motorcycles are hit in accidents. Most of the airbags consistent with the examples of the prior arts may be designed to be expanded for protecting the passengers by using sensors designed to measure or detect changes in velocities of the motorcycle or intensities of impacting forces to the motorcycle caused by the accident. However, there may still be other incidents that may cause a motorcycle to be turned over or lie on a side of the motorcycle after hitting the ground, such as the motorcycle may be pushed or hit while being parked or moving on a road, or a tire of the motorcycle may lose its friction with the ground when moving on a road and thus cause the motorcycle to slide down or turn over. In addition to a rider of the motorcycle may be scraped, slashed or weighed by the motorcycle in these situations, damage to the motorcycle caused by turning over to hit the ground may cost a lot of money for repairing the motorcycle. It may be desirable to have a protecting method or device for a motorcycle capable of measuring or detecting tilt of the motorcycle and inflating an airbag which may protect the motorcycle or reduce the damage if the motorcycle is going to be turned over, hit the ground or lie on its side, or may prevent a rider of the motorcycle from being hurt by the motorcycle, reduce injury to the rider from the motorcycle or push the rider's extremities or body to leave or be separated from the motorcycle before being weighed by the motorcycle.

To prevent damage to a motorcycle caused by turning over or lying on its side, some examples of the prior art may provide a protruding material such as a frame slider, a roller protector or a prop attached at the motorcycle. When the motorcycle is turned over, the frame slider, the roller protector or the prop may touch the ground before the bodywork, a frame or other parts of the motorcycle on the side, and thus may be capable of preventing or reducing damage to the motorcycle from hitting the ground directly. Moreover, the frame slider, the roller protector or the prop of the prior art may provide a space between the motorcycle and the ground when the motorcycle lies on the side, and this may prevent a rider's leg from being weighed by the motorcycle. However, in one situation, if the protruding material (the frame slider, the roller protector or the prop) is too big, it may not only influence an appearance or profile of the motorcycle, but also lower the safety of riding the motorcycle on a road or a street, especially in heavy traffic during a rush hour. In another situation, if the protruding material is too small, it may not be capable of providing enough protection to the motorcycle or the rider. Furthermore, it may become a fulcrum and cause the motorcycle to be turned over again after the protruding material impacts the ground. In both situations the protruding material may not be capable of providing enough protection to the motorcycle or the rider. Moreover, the protruding material itself may become a risk to the rider since the rider may be weighed by the motorcycle and the protruding material may stab or scrape the rider in an accident.

Therefore, it may be desirable to have a protecting method or device for a motorcycle capable of detecting or measuring the tilt of the motorcycle and providing a desired protection for the motorcycle or reducing the damage to the motorcycle, or preventing a rider of the motorcycle from being weighed or scraped by the motorcycle or reducing injury to the rider if the motorcycle is turned over while being parked or slides over while advancing on a road.

### BRIEF SUMMARY OF THE INVENTION

Examples of the present invention may provide a protecting device for a motorcycle. The protecting device may comprise a tilt-measuring module capable of measuring tilt of the motorcycle, an airbag capable of being inflated and expanding to cover an outer surface of the motorcycle, a comparing module capable of comparing the tilt with a tilting limitation and generating a inflating signal if the tilt achieves or exceeds the tilting limitation and an inflation module capable of generating a gas to inflate the airbag if the inflation module receives the inflating signal.

Examples of the present invention may provide another protecting device for a motorcycle. The protecting device may comprise a mercury switch capable of allowing or interrupting electric current according to tilt of the mercury switch, an inflating signal generating circuit capable of generating an inflating signal if the mercury switch allows or interrupts the electric current, wherein the mercury switch tilts according to tilt of the motorcycle and the mercury switch allows or interrupts the electric current if the tilt of the motorcycle achieves or exceeds a tilting limitation, an airbag capable of being inflated and expanding to cover an outer surface of the motorcycle and an inflation module capable of generating a gas to inflate the airbag if the inflation module receives the inflating signal.

Examples of the present invention may also provide a method for protecting a motorcycle. The method may comprise measuring tilt of the motorcycle, comparing the tilt with a tilting limitation and inflating an airbag to cover an outer surface of the motorcycle if the tilt achieves or exceeds the tilting limitation.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a diagram illustrating a protecting device for a motorcycle consistent with an example of the present invention;

FIG. 2 is a block diagram illustrating the protecting device shown in FIG. 1;

FIG. 3A is a diagram illustrating an operation of a protecting device consistent with an example of the present invention;

FIG. 3B is a diagram illustrating the operation of the protecting device in FIG. 3A if the motorcycle is turned over;

FIG. 4 is a diagram illustrating a protecting device for a motorcycle consistent with another example of the present invention; and

FIG. 5 is a flow chart illustrating a method for protecting a motorcycle consistent with yet another example of the present invention.

### DETAILED DESCRIPTION OF THE INVENTION

Reference will now be made in detail to the present embodiments of the invention, examples of which are illustrated in the accompanying drawings. Wherever possible, the same reference numbers will be used throughout the drawings to refer to the same or similar parts.

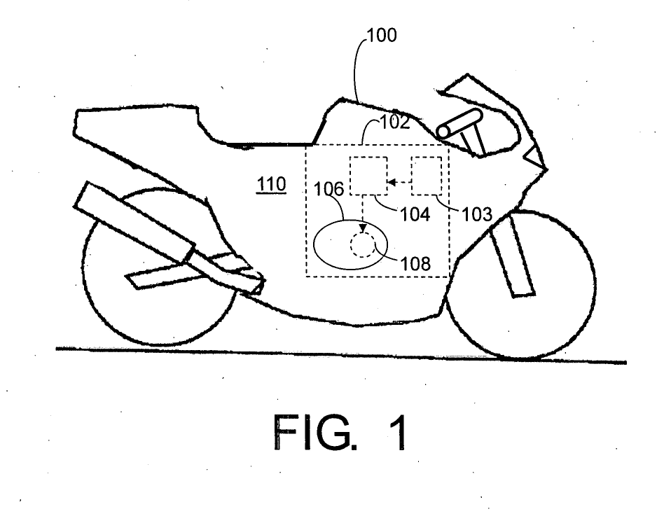

FIG. 1 is a diagram illustrating a protecting device 102 for a motorcycle 100 consistent with an example of the present invention. Referring to FIG. 1, the protecting device 102 may comprise a tilt-measuring module 103, a comparing module 104, an airbag 106 and an inflation module 108. The tilt-measuring module 103 may be capable of detecting tilt of the motorcycle 100. The airbag 106 may be capable of being inflated and expanding to cover an outer surface 110 of the motorcycle 100 if the airbag 106 is inflated, wherein the outer surface 110 may comprise a surface or a partial surface of at least one of bodywork (not numbered), a frame (not numbered), a fuel tank (not numbered), an engine (not numbered), an exhaust pipe (not numbered), a front fork (not numbered), a rim (not numbered), a steering handle (not numbered), a footrest (not numbered), a reversing mirror (not numbered), an indicator (not numbered), a swing arm (not numbered) and any other part attached to the motorcycle 100 such as a frame slider (not shown in FIG. 1) or a roller protector (not shown in FIG. 1). In one example, the outer surface 110 may also comprise a surface of the protecting device 102 if the protecting device 102 is attached on a side of the motorcycle 100. The inflation module 108 may be capable of generating a gas to inflate the airbag 106. In one example, the protecting device 102 may be disposed at the motorcycle 100. In another example, the protecting device 102 may be attached at the motorcycle 100 such as being attached to bodywork, a frame or another part of the motorcycle 100 similar to the frame slider, the roller protector or the prop of the prior arts attached at bodywork or a frame of a motorcycle.

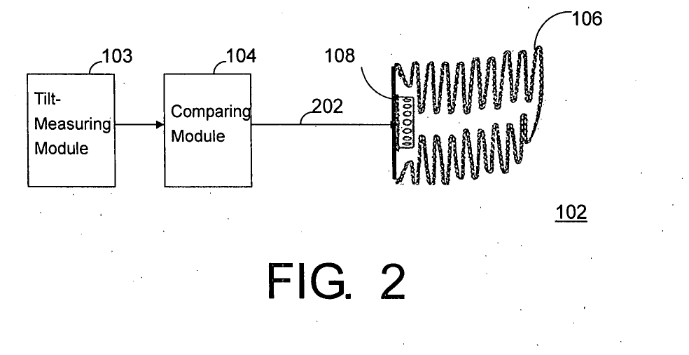

FIG. 2 is a block diagram illustrating the protecting device 102 shown in FIG. 1. Referring to FIG. 2, the protecting device 102 may comprise the tilt-measuring module 103, the comparing module 104, the airbag 106 and the inflation module 108. The tilt-measuring module 103 may be capable of measuring the tilt of the motorcycle 100. The comparing module 104 may be capable of comparing the tilt of the motorcycle 100 with a tilting limitation (not shown in FIG. 2) and generating an inflating signal 202 if the tilt achieves or exceeds the tilting limitation. The inflation module 108 may be capable of inflating the airbag 106 if the inflation module 108 receives the inflating signal 202. In one example, the inflation module 108 may be disposed inside the airbag 106 (as shown in FIG. 2), or disposed outside the airbag 106 but coupled to the airbag 106 such that once a gas is generated, the gas may be conducted into the airbag 106. Moreover, the airbag 106 may be folded or partially or totally wrapped with a retainer (not shown in FIG. 2) or a cover (not shown in FIG. 2), and after being inflated, the airbag 106 may be capable of expanding out of the retainer or the cover. Moreover, it will be appreciated by those skilled in the art that the inflation module may generate the gas by a dynamite material, an explosive material, an air pump or an inflator. In one example, the airbag 106 may comprise a cushion or a thick surface capable of protecting the motorcycle against the friction from the ground or absorb impact or shock if the motorcycle is turned over to hit the ground.

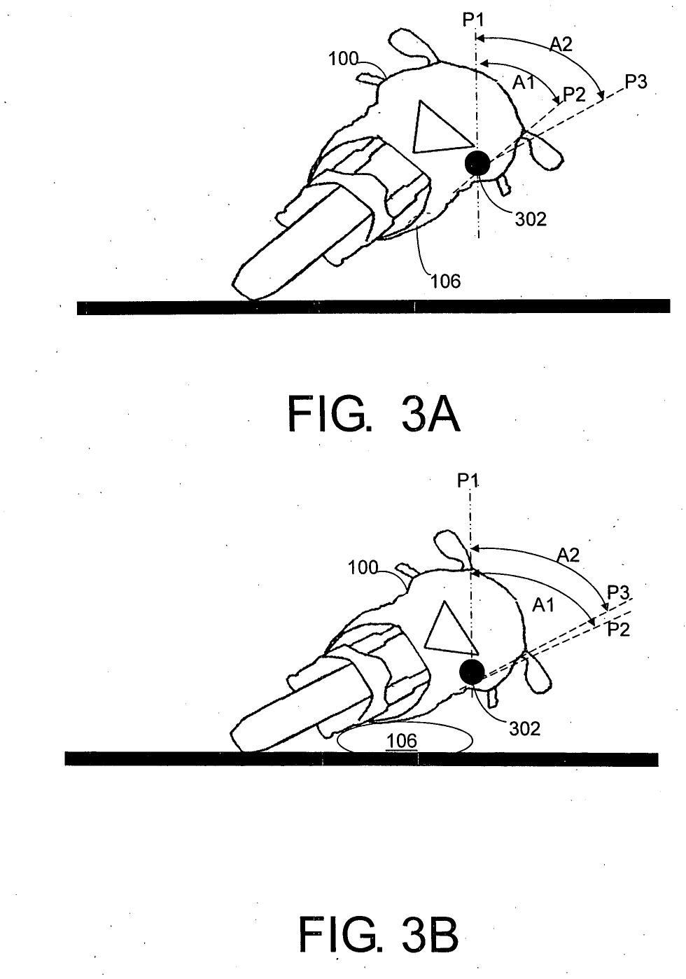

FIG. 3A is a diagram illustrating an operation of the protecting device 102 consistent with an example of the present invention, and FIG. 3B is a diagram illustrating the operation of the protecting device 102 in FIG. 3A if the motorcycle 100 is turned over. Referring to FIG. 3A, the tilt-measuring module 103 (not shown in FIG. 3A) may measure the tilt of the motorcycle 100 by measuring a tilting angle A1 of the motorcycle 100. The tilting angle A1 may be measured in a way equivalent to measure an angle between a first imaginary reference plane P1 to a second imaginary reference plane P2, wherein the second imaginary reference plane P2 tilts according to the tilt of the motorcycle 100. The comparing module 104 may compares the tilting angle A1 with a tilting angle limitation A2 (equivalent to an angle between the first imaginary plane P1 and a third imaginary plane P3). The comparing module 104 may generate the inflating signal 202 if the tilting angle A1 is bigger than or equal to the tilting angle limitation A2 as shown in FIG. 3B. The inflation module 108 may generate a gas to inflate the airbag 106 if the inflation module 108 receives the inflating signal 202. If the airbag 106 is inflated, the airbag 106 may be expanded to cover the outer surface 110 and touch the ground before the motorcycle 100, and thus may prevent or reduce damage to the motorcycle 100 caused by hitting the ground directly. In one example, the tilt-measuring module 103 may comprise a tilt-sensing IC, motion-sensing IC or an accelerometer (for example, a 3-axis accelerometer such as the iMEMS Accelerometer ADXL330 of Analog Devices, Inc) capable of measuring the tilting angle A1, and the comparing module 104 may comprise a logic circuit (not shown) capable of comparing the tilting angle A1 and the tilting angle limitation A2 and generating the inflating signal 202. Moreover, since a bounce or a shock of the motorcycle 100 caused by a rough or uneven road surface where the motorcycle 100 may move on or other electrical or mechanical interference may result in a noise signal when measuring the tilting angle A1 (e.g. a pulse of the noise signal may be mistaken by the logic circuit and cause the comparing module 104 to generate the inflating signal 202 to inflate the airbag 106), the comparing module 104 may further comprise a noise cancellation module, a digital signal processor (DSP) or a filtering module (e.g. a low-pass filter since the noise signal may usually have higher frequency) capable of reducing or eliminating the noise signal to get the desired measuring result signal. It will be appreciated by those skilled in the art that the tilting angle may be measured in a way equivalent to measure an angle between an imaginary tangential line, an imaginary tangential plane or an imaginary cross-section of the motorcycle and an imaginary reference line, an imaginary reference plane or horizontal, and thus the way of measuring the tilting angle A1 should not be limited to the exemplary diagrams. In another example, the tilt of the motorcycle 100 may be measured by measuring a moving distance (not shown) of a point 302 of the motorcycle. The tilt-measuring module 103 may measure the moving distance of the point 302. The comparing module 104 may compares the moving distance of the point 302 with a moving distance limitation (not shown) and generate the inflating signal 202 if the moving distance of the point 302 achieves or exceeds the moving distance limitation. Moreover, the moving distance of the point 302 may be measured by using the tilt-sensing IC, the motion-sensing IC or the accelerometer.

In still another example, the protecting device 102 may further comprise a setting module (not shown) capable of setting the tilting limitation such as the tilting angle limitation or the moving distance limitation. The protecting device 102 may further comprise a first switch (not shown) used to disable the airbag 106 or to make the inflation module 108 not be capable of inflating the airbag 106 if the first switch is switched off. In yet another example, the protecting device 102 may further comprise a second switch (not shown), wherein the inflation module 108 may inflate the airbag directly if the second switch is switched on, regardless to the tilt of the motorcycle 100.

In other example of the present invention, the motorcycle 100 may comprise a first wheel (not numbered), a second wheel (not numbered), a first tire (not numbered) and a second tire (not numbered), wherein the first tire is installed on the first wheel and the second tire is installed on the second wheel. The tilt-measuring module 103 may comprise a first tire-pressure gauge (not shown) and a second tire-pressure gauge (not shown). The first tire-pressure gauge may be capable of measuring a first tire pressure of the first tire and the second tire-pressure gauge may be capable of measuring a second tire pressure of the second tire. Furthermore, the comparing module 104 may generate the inflating signal 202 if at least one of the first tire-pressure achieves or exceeds a first tire-pressure limitation and the second tire-pressure achieves or exceeds a second tire-pressure limitation.

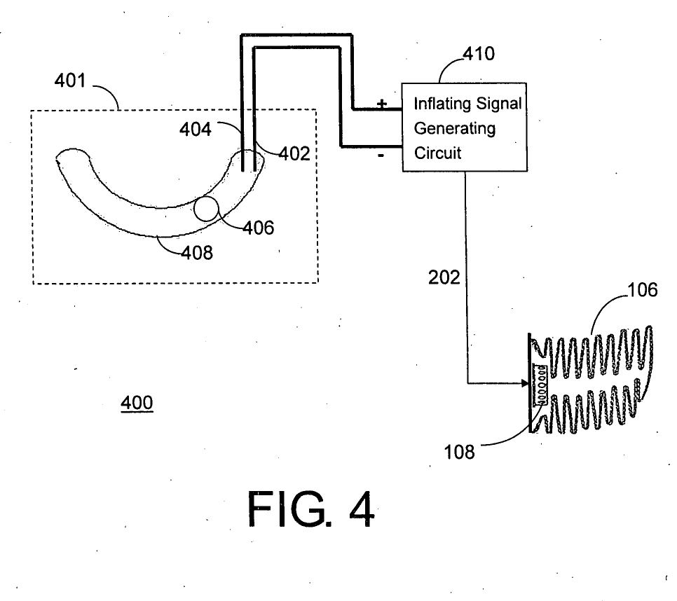

FIG. 4 is a diagram illustrating a protecting device 400 for a motorcycle consistent with another example of the present invention. Referring to FIG. 4, the protecting device 400 may comprise a mercury switch 401, an inflating signal generating circuit 410, an airbag 106 and an inflation module 108. The mercury switch 401 may comprise a container 408, mercury 406, a first electrode contact 402 and a second electrode contact 404. The mercury 406 may be move in the container 408 accordingly to the tilt of the motorcycle 100. Both of the first electrode contact 402 and the second electrode contact 404 may not be touched by the mercury 406 if the tilt of the motorcycle 100 does not achieve or exceed a tilting limitation. The inflating signal generating module 410 may be electrically coupled to the first electrode contact 402 and the second electrode contact 404 separately, and may generate the inflating signal 202 to the inflation module 108 to make the inflation module 108 inflate the airbag 106 if the tilt of the motorcycle 100 achieves or exceeds the tilting limitation to make the mercury 406 touch the first electrode contact 402 and the second electrode contact 404 at the same time and generate a electric current (not shown) to flow through the first electrode 402, the second electrode 404 and the inflating signal generating circuit 410 to make the inflating signal generating circuit 410 generate the inflating signal 202. It will also be appreciated by those skilled in the art that the container 408 is for containing the mercury 406, and thus the present invention should not be limited to the shape of the container 408 or the shape of space for the mercury 406 to move in the container 408. In other example, the inflating signal generating module 410 may also comprise a noise cancellation module or a filtering module (e.g. a low-pass filter) capable of reducing, eliminating or filtering out the noise caused by interference or a bounce or a shock of the motorcycle 100 when advancing on a road, and thus may prevent the inflating signal 202 from being generated in a wrong condition.

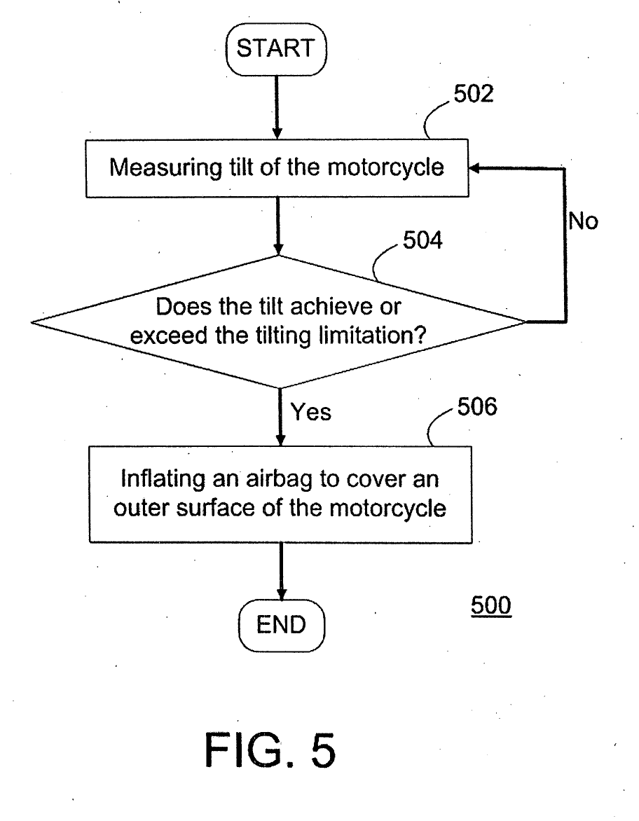

FIG. 5 is a flow chart illustrating a method 500 for protecting a motorcycle consistent with yet another example of the present invention. The method 500 may include step 502 measuring tilt of the motorcycle, step 504 determine if the tilt achieves or exceeds a tilting limitation and step 506 inflating an airbag to cover an outer surface of the motorcycle. In step 504, if the tilt achieves or exceeds the tilting limitation, then go to step 506 for inflating an airbag to protect the motorcycle from touching or hitting the ground directly, or if the tilt does not achieve or exceed the tilting limitation, then go back to step 502 for continuing measuring the tilt of the motorcycle.

It will also be appreciated by those skilled in the art that the tilt-measuring modules consistent with the examples illustrated above may also be capable of forming another tilt-measuring module by applying at least two kinds of the tilt-measuring modules for generating the inflating signal 202.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

I/We claim:

1. A protecting device for a motorcycle, the protecting device comprising:
a tilt-measuring module capable of measuring tilt of the motorcycle;
an airbag capable of being inflated and expanding out of or to cover an outer surface of the motorcycle;
a comparing module capable of comparing the tilt with a tilting limitation and generating an inflating signal if the tilt achieves or exceeds the tilting limitation; and
an inflation module capable of generating a gas to inflate the airbag if the inflation module receives the inflating signal.

2. The protecting device of claim 1, wherein the tilt-measuring module measures the tilt of the motorcycle by measuring a tilting angle of the motorcycle, the tilting limitation comprises a tilting angle limitation and the comparing module compares the tilting angle with the tilting angle limitation and generates the inflating signal if the tilting angle achieves or exceeds the tilting angle limitation.

3. The protecting device of claim 2, wherein the tilting angle is measured in a way equivalent to measure an angle between an imaginary tangential line, an imaginary tangential plane or an imaginary cross-section of the motorcycle and an imaginary reference line, an imaginary reference plane or horizontal.

4. The protecting device of claim 1, wherein the tilt-measuring module comprises at least one of a tilt-sensing IC, a motion-sensing IC and an accelerometer capable of measuring the tilt of the motorcycle.

5. The protecting device of claim 2, wherein the tilting angle is measured by at least one of a tilt-sensing IC, a motion-sensing IC and an accelerometer.

6. The protecting device of claim 1, wherein the tilt-measuring module measures the tilt of the motorcycle by measuring a moving distance of a point of the motorcycle, the tilting limitation comprises a moving distance limitation to the point of the motorcycle and the comparing module compares the moving distance with the moving distance limitation and generates the inflating signal if the moving distance achieves or exceeds the moving distance limitation.

7. The protecting device of claim 6, wherein the moving distance is measured by at least one of a tilt-sensing IC, a motion-sensing IC and an accelerometer.

8. The protecting device of claim 7, wherein the point is located at the tilt-measuring module, the tilt-sensing IC, the motion-sensing IC or the accelerometer.

9. The protecting device of claim 1, wherein the outer surface comprises a surface or a partial surface of at least one of bodywork, a frame, a fuel tank, an engine, an exhaust pipe, a front fork, a rim, a steering handle, a footrest, a reversing mirror, an indicator, a swing arm, a fairing, a protecting material attached on the motorcycle and the protecting device itself attached on the motorcycle.

10. The protecting device of claim 1, wherein a surface of the airbag comprises a cushion, a pad or a thick surface capable of protecting the motorcycle against the friction from the ground if the motorcycle is turned over.

11. The protecting device of claim 1, further comprises a setting module capable of setting the tilting limitation.

12. The protecting device of claim 1, further comprises a first switch, wherein the airbag is not capable of being inflated if the first switch is switched off.

13. The protecting device of claim 1, further comprises a second switch, wherein the inflation module inflates the airbag directly if the second switch is switched on.

14. The protecting device of claim 1, wherein the inflation module generates the gas by a dynamite material, an explosive material, an air pump or an inflator.

15. The protecting device of claim 1, wherein the motorcycle comprises a first wheel, a second wheel, a first tire and a second tire, the first tire being installed on the first wheel and the second tire being installed on the second wheel, the tilt-measuring module comprises:
a first tire-pressure gauge capable of measuring a first tire pressure of the first tire; and
a second tire-pressure gauge capable of measuring a second tire pressure of the second tire,
wherein the comparing module generates the inflating signal if at least one of the first tire-pressure achieves or exceeds a first tire-pressure limitation and the second tire-pressure achieves or exceeds a second tire-pressure limitation.

16. A protecting device for a motorcycle, the protecting device comprising:
a mercury switch capable of allowing or interrupting electric current according to tilt of the mercury switch;
a inflating signal generating circuit capable of generating an inflating signal if the mercury switch allows or interrupts the electric current,
wherein the mercury switch tilts according to tilt of the motorcycle and the mercury switch allows or interrupts the electric current if the tilt of the motorcycle achieves or exceeds a tilting limitation;
an airbag capable of being inflated and expanding to cover an outer surface of the motorcycle; and
an inflation module capable of generating a gas to inflate the airbag if the inflation module receives the inflating signal.

17. A method for protecting a motorcycle, the method comprising:
measuring tilt of the motorcycle;
comparing the tilt with a tilting limitation; and
inflating an airbag to cover an outer surface of the motorcycle if the tilt achieves or exceeds the tilting limitation.

18. The method of claim 17, wherein the measuring tilt of the motorcycle comprises measuring a tilting angle of the motorcycle.

19. The method of claim 18, wherein the tilting angle is formed between a reference line or a reference plane and a cross-section plane or a tangential plane of the motorcycle.

20. The method of claim 18, wherein the tilting limitation comprises a tilting angle limitation, the inflating an airbag to cover an outer surface of the motorcycle if the tilt achieves or exceeds the tilting limitation comprising inflating the airbag if the tilting angle achieves or exceeds the tilting angle limitation.
